(19) United States
(12) Patent Application Publication
(10) Pub. No.: US 2002/0071713 A1
(43) Pub. Date: Jun. 13, 2002

(54) Holding device particularly for the fixing and/or release of mounted parts

(76) Inventor: Wolfgang Harwath-Seyfried, Villingen-Schwenningen (DE)

Correspondence Address: M. Robert Kestenbaum, 11011 Bermuda Dunes NE, Albuquerque, NM, 87111, US

(21) Appl. No.: 09/949,209

(22) Filed: Sep. 6, 2001

(30) Foreign Application Priority Data
Sep. 6, 2000 (DE) 200 15 391.9

(51) Int. Cl. F16B 1/00

(52) U.S. Cl. 403/11

(57) ABSTRACT

Holding device particularly for the fixing and/or release of installed parts in the field of vehicle manufacture and/or maintenance, characterized by a magnetizing body (1, 1a, 1b, 1e) with an operating means (2) arranged on it. The object of the invention is, therefore, to show how a large number of different individual parts and/or mounted parts can be held in the simplest possible way, particularly for fixing or release.

### DESCRIPTION

The invention relates to a holding device particularly for the fixing of mounted parts and/or protective devices in the field of vehicle manufacture and/or vehicle maintenance.

Individual components have to be connected rigidly or moveably to one another in many particularly industrial sectors, such as, for example, in the field of vehicle manufacture and/or vehicle maintenance or repair.

In this context, essentially irrespective of the type of mutual fastening, such as, for example, via a screwed or riveted connection or a soldered or welded joint, normally the components to be connected to one another have first to be held in order to be appropriately aligned with one another and fixed. When, on the other hand, components connected to one another are released from one another, for example in order to exchange a damaged component for a new one, in many instances at least one of the two components then has to be held.

Without general validity being limited, reference may be made here, by way of example, to the installation of a motor vehicle door or to the exchange of one vehicle door for another.

In this case, holding during the fixing and/or release of individual components or mounted parts is conventionally carried out manually or else using gripping tools. However, in many cases, manual holding is possible only to a limited extent or, in particular, is dependent on the shape and/or size of a component of this kind. Furthermore, gripping around components of this type, such as, for example, the abovementioned vehicle door, may lead to injuries, particularly due to sharp edges and/or pinching in the hinge region where the door is to be connected to or released from the body.

In the case of gripping tools, essentially irrespective of whether these are operated manually or mechanically, it is normally necessary, for gripping itself, to have sufficient access to the component to be fastened or fixed or to be released, Particularly in the field of vehicle and/or body technology, but also in other fields in which the aim is to achieve an optimum utilization of the available space or room, particularly for economic reasons, this, as a rule, has adverse effects on accessibility.

However, similar problems also arise, for example, in the only temporary fixing of protective devices, in particular when work has to be carried out on a region of a device and adjacent regions have to be protected from damage as a result of this work. As an example of this, reference may be made again to the motor vehicle sector where welding work has to be carried out on the body part, whilst the rest of the vehicle must be protected, in particular, against sparks being thrown off.

In such a case, manual holding of protective devices is essentially ruled out. Moreover, the fastening of a protective device suitable for this purpose is often possible only at a high outlay or is likewise ruled out, so that the vehicle part to be machined first has to be released from the rest of the vehicle and remounted after the work is carried out.

The object of the invention is, therefore, to show how a large number of different individual parts and/or mounted parts can be held in the simplest possible way, particularly for fixing or release.

The solution according to the invention for achieving the object is characterized in an extremely surprising way by a holding device having the features of claim 1.

Advantageous and/or preferred embodiments or developments are the subject-matter of the subclaims.

According to the invention, therefore, a holding device for the fixing and/or release of particularly mounted parts in the field of vehicle manufacture and/or vehicle maintenance is provided, said holding device comprising a magnetizing body with an operating means arranged on it.

It is advantageous in this case, in particular, that, as regards essentially all mounted parts which are to be fixed and/or released and comprise a magnetizable material, these can be held on the surface, essentially irrespective of the shape and/or size, by means of the magnetizing body and it is no longer necessary to grip around them in order to hold them. Furthermore, it is possible to hold, in particular, thin-walled components, such as, for example, protective devices, by means of the holding device according to the invention between the magnetizing body and a magnetizable countersurface in the preferably directly adjacent region of a part to be machined.

Moreover, the operating means arranged on the magnetizing body ensures that a component adhering to the magnetizing body, in particular for fixing and/or release, is held simply and easily.

In a practical embodiment, there is provision for the operating means to be designed as a simple handle, so that a user of the holding device according to the invention can employ the latter flexibly in the simplest possible way, Moreover, to make, in particular, a multiplicity of successive work steps even simpler, there expediently is provision for connecting the operating means releasably to the magnetizing body, so that, once the magnetizing body has adhered to a component to be fixed and/or released, said body in many cases no longer has to be released for intermediate work steps, since it is often sufficient simply to release the operating means arranged on the magnetizing body from the latter. This ensures, for example, that various magnetizing bodies can be put in place with an operating means, and, if required, the operating means can be arranged releasably again at selected points. On the other hand, the operating means arranged releasably on the magnetizing body can simply be removed, for example in order to carry out intermediate operations which cannot otherwise be carried out.

In a particularly preferred way the holding device is designed, moreover, with a further receiving means for receiving associated fixing means, such a receiving means expediently being arranged between the operating means and the magnetizing body. As a result, for example, a fixing means designed as a spacer, together with a further component capable of being arranged on it, can be received additionally via the holding device according to the invention.

In order further to improve the holding properties of the holding device according to the invention, the invention provides, furthermore, as a development, for the magnetizing body to comprise a multiplicity of individual magnetic elements which are arranged next to one another, preferably over an area, depending on the field of use, or are arranged in a layered manner, in each case separated from one another by insulating means, in order to improve the magnetic flux densities which can be achieved.

Moreover, in a preferred development, there is provision for designing the holding device with a means for changing the polarity, so that it becomes possible for the magnetizing body to be switched on and oft via a corresponding reversal of polarity and, in a particularly expedient version, an, in particular, continuously adjustable magnetization of the magnetizing body of the holding device can be carried out.

In order to rule out essentially completely damage to the magnetizable component which is to be held by the holding device, there is provision, furthermore, for the magnetizing body to be covered by a protective sheath, expediently consisting of a rubber-containing material.

The invention is described in detail below by the example of three preferred embodiments, with reference to the accompanying drawings in which:

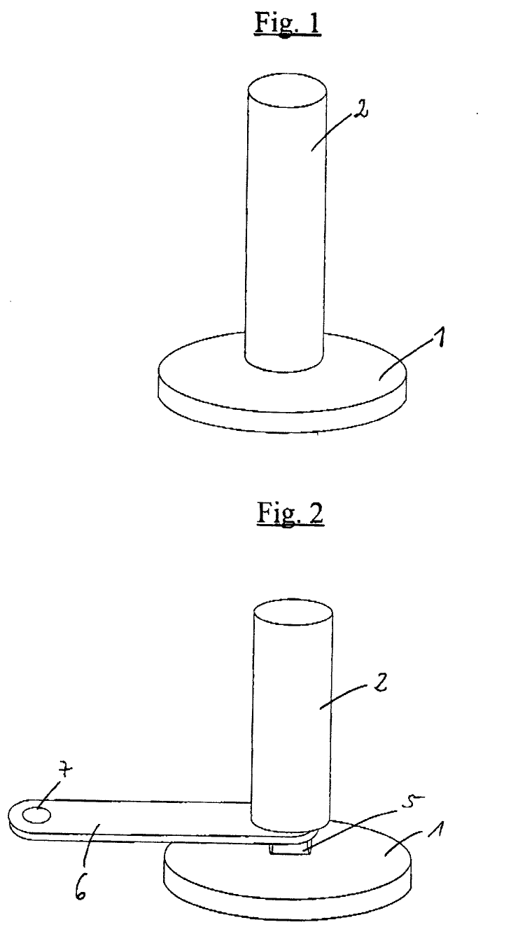

FIG. 1 shows a first embodiment according to the invention of the holding device,

FIG. 2 shows a second embodiment according to the invention of the holding device with an additional receiving means,

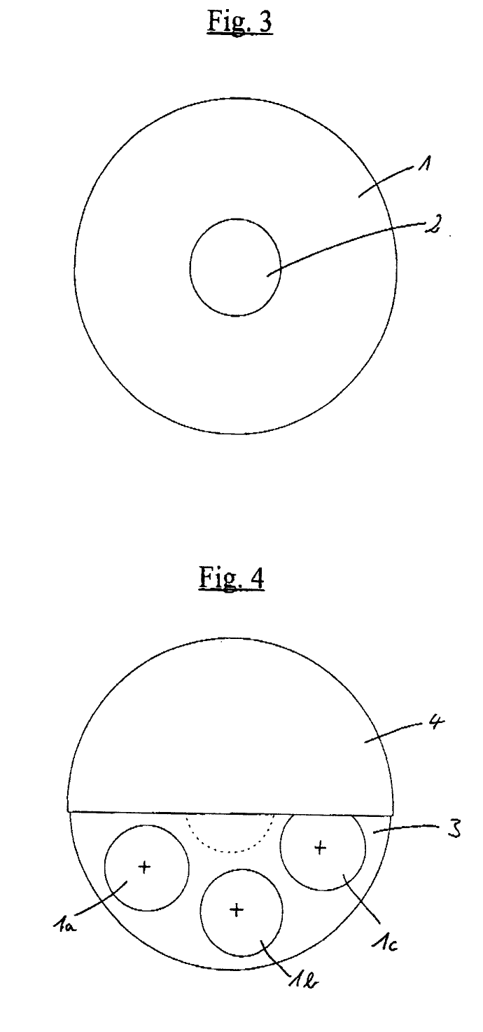

FIG. 3 shows a top view of the embodiment according to FIG. 1,

FIG. 4 shows a partially cut away bottom view of an embodiment similar to the embodiment of FIG. 1, but with a multiplicity of magnetic elements,

FIG. 5 shows a side view of a third embodiment according to the invention, and

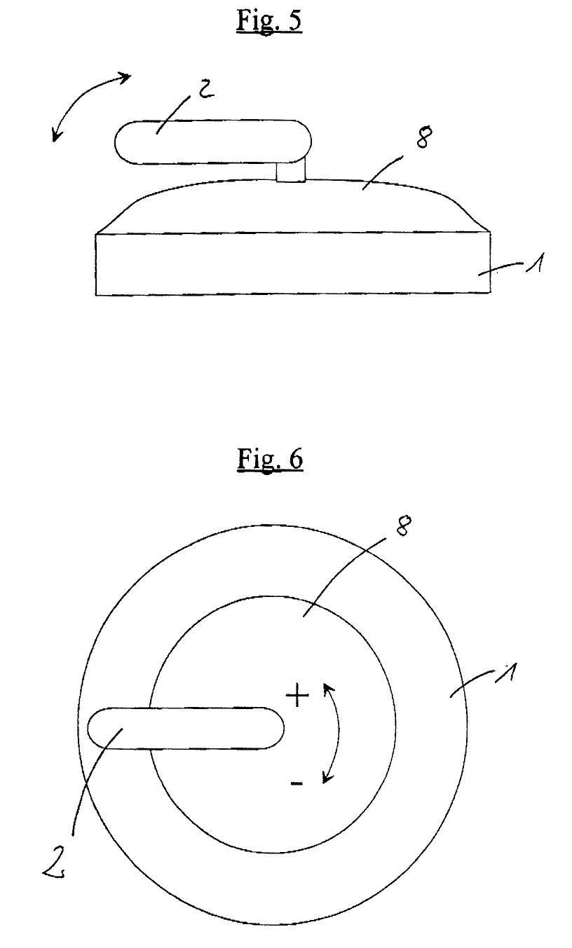

FIG. 6 shows a top view of an embodiment similar to the embodiment of FIG. 5.

It should first be pointed out, with regard to the following description, that identical or identically acting parts are given the same reference symbols in the figures.

Reference is made below to FIG. 1, in conjunction with FIG. 3, which illustrate by way of example a first embodiment of the holding device according to the invention.

The holding device according to FIG. 1 comprises, as a magnetizing body 1, a magnet on which a handle 2 is arranged. In a practical version, the handle 2 is expediently provided with a plastic covering increasing the gripping strength for the user and is connected to the magnet 1 by fastening methods known per se to a person skilled in the art, such as, for example, by adhesive bonding or welding. As may be seen, in particular from FIG. 3, such an embodiment ensures a large-area bearing surface for the magnet 1 on a component to be held, such as, in particular, a mounting part to be fixed or released.

Furthermore, by means of this embodiment, a simple “clamping” hold of, for example, protective devices, such as protective tarpaulins, between a magnet 1 and a magnetizable component, for example a body part, is ensured in the immediate vicinity of work to be carried out, so that adjacent regions are protected from damage.

In an embodiment according to FIG. 4, similar to that of FIGS. 1 and 3, the magnetizing body comprises a multiplicity of individual magnetic elements 1a, 1b, 1c which are embedded in a metal disc 3. Moreover, as may be gathered from the partially cut away view, this arrangement is covered by a protective sheath 4, consisting of a rubber material in the present exemplary embodiment, so that damage is essentially ruled out when magnetizable components are held.

Furthermore, by a number of individual magnetic elements 1a, 1b, 1c being arranged in the way illustrated in FIG. 4, the magnetic moment as a whole is increased, as compared with an individual disc-shaped magnet 1, as in FIGS. 1 and 3.

It may be pointed out, however, that the invention also embraces embodiments which, particularly in order to achieve higher magnetic flux densities, are formed, for example, by the layered arrangement of magnetic elements with insulating means, such as, in particular, insulating wafers or foils, lying between them.

FIG. 2 shows an embodiment in which a handle 2 is connected releasably to the magnetizing body 1. For this purpose, in a practical embodiment, there is provision for an intermediate element 5 arranged firmly on the magnetizing body 1 to be designed with an internal thread, not illustrated, into which can be screwed a bolt or pin arranged on the handle 2 and provided with a correspondingly complimentary external thread.

In the embodiment according to FIG. 2, furthermore, the tenon-shaped intermediate element 5 forms a receiving means for an associated fixing means 6. For this purpose, the tenon 5 has an essentially cubic outer shape, onto which the fixing means 6 can be placed by means of a corresponding passage orifice. After the holding device adheres to a component to be held, a further component, such as, for example, a protective device, or a further mounted part to be oriented can be held at a fixed distance via the fixing means 6 and a passage orifice 7 arranged on the latter.

FIGS. 5 and 6 illustrate diagrammatically two further embodiments of the holding device according to the invention, in which the magnetic polarization of the respective magnetizing body 1 can be changed. A polarizing means 8, illustrated diagrammatically in FIG. 5, has the effect, in this case, that, by the handle 2 being moved to an upright position, a magnetic pole arranged on it is brought near to the magnetizing body 1, with the result that the magnetic polarization and the resulting magnetic field of the magnetizing body 1 can expediently be adjusted continuously. By the handle 2 being lowered into the position illustrated in FIG. 5, the polarization of the magnetizing body 1 disappears essentially completely and the holding device can 5 be released as a whole from the component to be held.

In the embodiment illustrated in FIG. 6, the magnetizing body 1 can be switched on and off by the handle 2 being rotated in one of the directions illustrated by the double arrow. In the present exemplary embodiment, rotation in the direction of the “+” sign has the effect that the magnetizing body 1 is switched on and rotation of the handle 2 in the direction of the “−” sign has the effect that the magnetizing body 1 is switched off.

The invention thus embraces embodiments in which the magnetizing body is designed as a permanent magnet, for example as in FIGS. 1 to 4. Furthermore, referring to FIGS. 5 and 6, it embraces embodiments in which the magnetizing body is formed on an, in particular, ferromagnetic element which ensures polarization.

It may be pointed out, however, that, furthermore, the invention embraces embodiments in which the magnetizing body is designed, for example, as an electromagnet.

1. Holding device particularly for the fixing and/or release of installed parts in the field of vehicle manufacture and/or maintenance, characterized by a magnetizing body (1, 1a, 1b, 1c) with an operating means (2) arranged on it.

2. Holding device according to claim 1, characterized in that the operating means (2) is connected releasably to the magnetizing body (1, 1a, 1b, 1c).

3. Holding device according to claim 1 or 2, characterized by a means (5) for receiving at least one associatable fixing means (6) the receiving device (5) being arranged preferably between the operating means (2) and the magnetizing body (1, 1a, 1b, 1c).

4. Holding device according to one of claims 1 to 3, characterized in that the magnetizing body comprises a multiplicity of magnetic elements (1a, 1b, 1c).

5. Holding device according to one of claims 1 to 4, characterized by a means (8) for changing the polarity.

6. Holding device according to one of claims 1 to 5, characterized in that the magnetic field of magnetizing body (1, 1a, 1b, 1c) is, in particular, continuously adjustable.

7. Holding device according to one of claims 1 to 6, characterized in that the magnetizing body (1) is surrounded essentially completely by a protective sheath (4).

8. Holding device according to claim 7, characterized in that the protective sheath (4) comprises rubber-containing material.

9. Holding device according to one of claims 1 to 8, characterized in that the operating means (2) is designed as a handle.
